(19) United States
(12) Patent Application Publication
(10) Pub. No.: US 2007/0190253 A1
(43) Pub. Date: Aug. 16, 2007

(54) Method of applying and drying liquid

(76) Inventor: Masafumi Matsunaga, Tokyo (JP)

Correspondence Address: WOOD, HERRON & EVANS, LLP (NORDSON), 2700 CAREW TOWER, 441 VINE STREET, CINCINNATI, OH, 45202, US

(21) Appl. No.: 10/554,839

(22) PCT Filed: Apr. 30, 2004
(86) PCT No.: PCT/JP04/06347

§ 371 Date: Jan. 25, 2007

(30) Foreign Application Priority Data
May 1, 2003 (JP) 2003-126499
Apr. 12, 2004 (JP) 2004-116661

(51) Int. Cl. B08B 3/00; B08B 7/00; B05D 1/32; B05D 3/02

(52) U.S. Cl. 427/282; 134/33; 134/26; 427/372.2; 427/115

(57) ABSTRACT

A method of applying and drying a liquid, with which a high-quality coating film can be formed by applying a liquid on an object and drying the object in a short time. The method includes: sucking an object (6) on an air-permeability circulating member (2); applying a liquid (14) into a thin film on the object sucked on the circulating member while staking the thin films on top of one another; and drying the liquid applied on the object at least to the touch.

### TECHNICAL FIELD

The present invention relates to a method of applying and drying a liquid. In particular, the present invention relates to a method of sucking an object (or a substrate) such as a web on a porous circulating member such as a screen belt or a screen drum through vacuuming and applying a liquid on the object to dry the liquid at least to the touch.

### BACKGROUND ART

Up to now, there has been known a method of heating a web as an object and applying a liquid on the heated web (see JP 10-76220 A, for example). In this method, a vacuum mechanism is provided opposite to a die head for applying the liquid. The liquid is applied from the die head on a surface of a porous or air-permeability web while sucked from a rear side of the web using the vacuum mechanism, making it easy to infiltrate the liquid into fine pores of the web.

Meanwhile, a method of applying a liquid such as a coating containing a solvent medium such as water or a solvent on an object of any possible shape and drying the liquid in a hot air drying furnace is being widely employed in the coating industry for the following reasons. That is, the method enables drying in a range of a low temperature to a high temperature in a simple manner, and enables a relatively precise temperature control. The hot air drying furnace is being widely adopted for applying a liquid coating material or an adhesive on a continuously fed web as well as for printing with a liquid ink for the above reasons. On the other hand, if the object is, for example, a metal-made coil having a heat resistance and a simple shape, a fast drying method utilizing induction heating may be used. For a web of non-magnetic plastics or paper, or a composite web, drying with far infrared irradiation is used because of its far superior heat transfer efficiency to that of the heated air and also for the purpose of activating the coating film from the inside. Recently, the following method has been also used, which aims at treatment in a short time. That is, a photopolymerization initiator etc. are added to an oligomer or monomer selected so as to cure the coating material or adhesive by reaction with irradiation of UV light, a visible light, or an electron beam and an objective liquid is prepared. The prepared liquid is then applied on the object and cured by the UV irradiation etc. as mentioned above.

However, even when the object used has a simple shape like a sheet or web, the problem of restrictions on the coating material or on the temperature control remains to be solved. Accordingly, the hot air drying furnace has been still widely used.

In recent years, development of a fuel cell is being in progress. A method of forming a power generating layer of the fuel cell has been proposed (see JP 2001-70863 A). JP 2001-70863 A discloses a method of applying a liquid suitable for forming a power generating layer of a proton-exchange membrane fuel cell. The method includes applying a catalyst layer (ink), which is made of a carbon powder carrying platinum, on a thin film 24 that is easily wetted (damped), such as perfluorosulfonic ionomer. With the method of applying the liquid, the thin film is transported under heating while sucked on a suction heating roller, and the thin film that is being transported is applied with the ink and then dried.

Conventional hot air drying furnaces are simple but involve the following problems. Firstly, the method provides a poor efficiency in terms of heat transfer to the object and requires 10 to 30 minutes for drying in general, which leads to a considerable energy loss. In particular, come-up time necessary for the object to reach a preset temperature is 2 to 3 minutes, which causes a problem to be solved from the viewpoints of global environment such as a larger emission amount of carbon dioxide as well as energy saving. Secondly, the method requires a long drying time because of poor drying efficiency, and thus a large installation space is required. Thirdly, the coating film surface of the object is first dried, so that in the case of a thick coating film, in particular, the coating film undergoes skinning to confine the solvent existent inside the object. This results in generation of blisters, bubbles, or cracks, and considerably decreases the quality. Fourthly, as a problem inherent in not only the hot air drying furnace but also all drying devices, no satisfactory drying method has been found for an object swelled with the solvent, for example, a rubber sheet or “Nafion”™, registered product of DuPont Co. used as an electrolyte membrane of a PEFC (proton-exchange membrane fuel cell) that is a type of the fuel cell.

### DISCLOSURE OF THE INVENTION

The present invention has been made in view of the above-mentioned problems and accordingly has an object to provide a method of applying and drying a liquid, which includes applying the liquid to a sheet or web and forming a high-quality coating film in a short time.

In order to attain the above-mentioned object, the present invention provides a method of applying and drying a liquid as mentioned below.

That is, the method of applying and drying a liquid includes: sucking an object on an air-permeability circulating member as firmly as possible; applying the liquid on the object sucked on the circulating member while stacking the liquid on top of one another, preferably staking thin films of the liquid on top of one another; letting out a solvent (steam) on an application surface with a synergetic effect of increasing an air velocity or air flow; and drying the liquid applied on the object at least to the touch.

According to an aspect of the present invention, a method of applying and drying a liquid, includes: sucking an object on an air-permeability circulating member; applying the liquid on the object sucked on the circulating member while stacking the liquid on top of one another; and drying the liquid applied on the object at least to the touch.

In further aspect of the method of applying and drying a liquid, the liquid applied on the object may be exposed to an air flow.

It is preferable to provide means for rapidly letting out the solvent on the application surface. For example, it is preferable to increase the air flow or the air velocity near the application surface to 0.5 m/s or higher.

In further aspect of the method of applying and drying a liquid, the liquid may be applied on the object by using a pulse spray method.

According to another aspect of the present invention, a method of applying and drying a liquid, includes: sucking an object on an air-permeability circulating member in a vacuum chamber; applying the liquid on the object sucked on the circulating member in the vacuum chamber; and drying the liquid applied on the object at least to the touch in the vacuum chamber.

According to another aspect of the present invention, a method of applying and drying a liquid, includes: interposing an air-permeability substrate between an air-permeability circulating member and an object and sucking the air-permeability substrate together with the object to the circulating member to move them with the circulating member; applying the liquid on the object sucked on the circulating member through the air-permeability substrate; and drying the liquid applied on the object at least to the touch.

According to another aspect of the present invention, a method of applying and drying a liquid, includes: making a masking web adhere to a surface of an object; sucking the object on an air-permeability circulating member; applying the liquid on the object sucked on the air-permeability circulating member; and drying the liquid applied on the object at least to the touch.

According to another aspect of the present invention, a method of applying and drying a liquid, includes: interposing an air-permeability substrate between an air-permeability circulating member and an object and sucking the air-permeability substrate together with the object to the circulating member to move them with the circulating member; making a masking web adhere to a surface of the object; applying the liquid on the object sucked on the circulating member through the air-permeability substrate; and drying the liquid applied on the object at least to the touch.

The circulating member may be heated.

The surface of the circulating member may include an air-permeability screen drum or screen belt, and the screen drum or the screen belt may be heated from the inside.

The object may be a web.

The applying may include atomizing the liquid into particles.

A coating film dried at least to the touch on the object may be further dried in a vacuum chamber.

At least the coating film may be further heated by a heater in the vacuum chamber.

The method of applying and drying the liquid may be performed in a vacuum chamber.

The liquid may be an electrode-ink for a proton-exchange membrane fuel cell, and the object to be coated may be an electrolyte membrane.

In further aspect of the method of applying and drying a liquid, the method may further include: interposing an air-permeability substrate between the object and the circulating member; and sucking the air-permeability substrate together with the object to the circulating member to move them with the circulating member.

In further aspect of the method of applying and drying a liquid, the method may further include transferring heat from the circulating member to the object so that a surface of a coating film of the liquid on the object is dried at least to the touch until the object is stripped off from the circulating member.

In further aspect of the method of applying and drying a liquid, an operation of applying and drying electrode inks for an anode and a cathode may be performed in one line.

In further aspect of the method of applying and drying a liquid, the method may further include: making a masking web self-adhere to the surface of the object or selecting a self-adhesive masking web; or making a masking web adhere to the surface of the object with an adhesive.

According to another aspect of the present invention, a method of applying and drying a liquid, includes: sucking an object on an air-permeability circulating member; applying the liquid from a slot nozzle on the object sucked on the circulating member while stacking the liquid on top of one another; and drying the liquid applied on the object at least to the touch.

The object may have an air-permeability, and the liquid may be filled into the object having the air-permeability from the slot nozzle plural times.

The liquid may include an electrolyte solution.

The object may be dried by heating the circulating member.

The object may be dried in a vacuum chamber.

### BRIEF DESCRIPTION OF THE DRAWINGS

FIG. 1 is a schematic diagram showing a applying and drying device 1 for carrying out a method of applying and drying a liquid according to the present invention;

FIG. 2 is an exploded view showing a circulating member 2;

FIG. 3 is a sectional view taken along an axial direction of the circulating member 2 and along the line III-III of FIG. 4;

FIG. 4 is a cross-sectional view of the circulating member 2 taken along the line IV-IV of FIG. 3;

FIG. 5 is a partial enlarged view of the surface of a cylinder 23 of the circulating member 2;

FIG. 6 is a schematic diagram showing a circulating member 42 using a screen belt 52;

FIG. 7 is a perspective view showing a vacuum plate 55;

FIG. 8 is a sectional view showing the vacuum plate 55;

FIG. 9 is a plan view showing a heating plate 56;

FIG. 10 is a schematic view showing an example where a drying device 70 is added to the applying and drying device 1 of FIG. 1;

FIG. 11 is a schematic view showing an example where the drying device 70 is added to an applying and drying device 41 of FIG. 6;

FIG. 12 shows an example where a heating roller 72 is added to the drying device 70 in the example of FIG. 10;

FIG. 13 shows an example where the heating roller 72 is added to the drying device 70 in the example of FIG. 11;

FIG. 14 shows a drying device 170 having a heating circulating member 120;

FIG. 15 is a schematic view showing an example where a drying device 75 is added to the applying and drying device 1 of FIG. 1;

FIG. 16 is a schematic view showing an example where the drying device 75 is added to the applying and drying device 41 of FIG. 6;

FIG. 17 is a schematic view showing an example where a masking web 80 is used in the applying and drying device 1 of FIG. 1;

FIG. 18 is a schematic view showing an example where the masking web 80 is used in the applying and drying device 41 of FIG. 6;

FIG. 19 is a plan view showing the masking web 80;

FIG. 20 is a schematic view showing an example where an underlying web 90 is used in the applying and drying device 41 of FIG. 6;

FIG. 21 is a plan view illustrative of how an applying device 44 of FIG. 20 applies a liquid;

FIG. 22 is a schematic view showing an example where the masking web 80 and the underlying web 90 are used in the applying and drying device 41 of FIG. 6;

FIG. 23 shows how the underlying web 90, a web 46 as an object, and the masking web 80 overlap one another;

FIG. 24 shows a modification of the masking web;

FIG. 25 shows the web 46 applied with the liquid;

FIG. 26 shows an embodiment of the present invention, in which the liquid is applied plural times on top of one another;

FIG. 27 shows another embodiment of the present invention, in which the liquid is applied plural times on top of one another;

FIG. 28 shows an embodiment of the present invention, in which the liquid is applied plural times on top of one another by use of plural slot nozzles 141 and 142;

FIG. 29 is a conceptual view illustrative of a method of applying thin films of liquid while stacking the thin films on top of one another;

FIG. 30 is a schematic diagram showing a liquid applying and drying device 301 utilizing stacked application and blow drying;

FIG. 31 is a schematic diagram showing another applying and drying device 401;

FIG. 32 is a schematic diagram showing a liquid applying and drying device 501 using a sucking device;

FIG. 33 is a schematic diagram showing an example where the underlying web is used in the liquid applying and drying device 501 using the sucking device; and

FIG. 34 is a schematic diagram showing a liquid applying and drying device using a vacuum chamber.

### BEST MODE FOR CARRYING OUT THE INVENTION

Hereinafter, the present invention will be described based on a preferred embodiment mode of the present invention. Note that a size, material, shape, positional relation, etc. of components described in the following embodiment mode should not be construed as limiting the scope of the present invention to those unless otherwise specified.

According to the present invention, a liquid is applied on a surface of an object sucked and stably held on a circulating member, by which the object moves together with the circulating member without deforming. In addition, heat is transferred through the circulating member, which prevents the surface from skinning as is the case with a hot air furnace. Further, as compared with a far infrared heater that activates a coating film from the inside but involves a large variation in temperature control, the present invention can yield a high-quality coating film and a product thereof.

More specifically, a screen belt of 40 or more meshes, a screen drum manufactured by Stork Inc. and used in the field of screen printing, or a sintered porous drum made of metal oxide or metal, for example, may be ideally used. In addition, if required, air-permeability natural or fossil woven cloth or non-woven cloth, Japanese paper, synthetic paper, a plastic film, for example, “DELNET”® produced by Delstar Technologies, Inc. or “POREFUL” produced by OHE CHEMICALS INC., and the like may be supplied thereon in a single layer form or in a multi-layer form, ideally in a web form, to suck the object. The object to be sucked thereon can be completely sucked due to the more finely dispersing effect of a vacuum. Thus, even if the object is a plastic film with a thickness of 15 μm, for example, the film can be surely sucked on the circulating member with leaving no trace of air holes of the circulating member. Another feature thereof is that a fine air-permeability substrate such as paper is allowed to adhere to an air-permeable drum etc., and the object is sucked thereon. As a result, a pore size of an air communication portion of the drum can be increased, and also a low density suffices therefor, which leads to a remarkable cost reduction. An air-permeability seamless drum or screen having a diameter above 500 mm is expensive. If its diameter is increased to even 3,000 mm as is expected for production lines in the near future, its price will become astronomical. What is worse is that such production itself may not be possible in some cases. According to the present invention, a commercially available metal punching plate or screen is subjected to seam welding into a cylindrical shape and placed onto the circulating member such as a drum or used as a belt, thus requiring much lower cost. Also, a sintered plate made of metal or metal oxide can be bonded to the drum. Even the rubber sheet or “Nafion”® film does not undergo swelling and deforming due to a suction force thereof for a while after applying electrode ink. Accordingly, it is necessary to dry the coating film and the solvent that is infiltrating into the object by heating from the circulating member side as early as possible, ideally, simultaneously with the application. Note that in some cases, it is important to allow a trace amount of solvent to infiltrate into the object from the viewpoint of adhesion of the coating film. Since “Nafion”® is easily swelled with the moisture or solvent as discussed above, the following method has been often adopted up to now. That is, the electrode ink is not directly applied to “Nafion”® but applied to a PTFE film or other like films and dried, and then transferred under heat and pressure to “Nafion”® according to a desired pattern. However, with this method, a solid content of the electrode ink is around 10% at most. Thus, for attaining a dry weight of 1 to 4 mg per square centimeter (cm²), a wet film thickness needs to be as large as about 100 to 400 μm. When aiming at drying in a relatively short time with hot air drying, the skinning, cracks, and blisters may develop in the surface. For that reason, hot air drying has to be performed at a low temperature. Considering a line speed of 10 meters or higher per minute which will be required in the near future, the requisite time and installation space therefor will become overwhelmingly large.

The object of any shape such as a sheet shape or web shape may be used without particular limitations but the web shape is preferred in consideration of productivity.

As regards movement of the circulating member in each step as it moves with the object sucked thereon, the liquid is applied while moving the object and the applying device relative to each other during the application operation. However, it is also possible to apply the liquid on the object while, for example, suspending the movement of the circulating member, and then securing the applying device in place or moving it in the moving (advancing) direction of the circulating member. Alternatively, in the case of using an object with a larger width than the coating pattern, the applying device may apply the liquid while moving in the direction crossing the moving direction of the circulating member. It is possible to dry the object while stopping the circulating member from moving. Needless to say, both application and drying can be performed while moving the circulating member. Regarding the movement mode, for example, in the case of using a drum as the circulating member, the drum may be continuously rotated. For stacking the coating films of the liquid more finely, the rotation may be intermittently performed little by little at a desired rotation angle; a drum having a diameter of 200 mm, for example, may be rotated by 0.5 to 10 degrees at a time and a drum having a diameter of 1,000 mm may be rotated by 0.1 to 2 degrees at a time. To elaborate, the object sucked on the circulating member may be moved continuously in the moving direction or moved intermittently. Assume that the aforementioned applying device is a spray gun, and the spray gun is attached to a traverse gear and adapted to apply the liquid while moving in the direction crossing the moving direction of the circulating member. When the above operation is conducted while the intermittent movement is suspended, recoating is uniformly performed in a stable manner, leading to the improved quality.

Also, the coating method may be, although not particularly limited, any of roll coating, bar coating, slot nozzle coating, screen printing, curtain coating, and spray coating. In the case of applying the liquid plural times, those may be used in combination by making use of their respective characteristics. However, in particular, for the object easily swelled with the solvent, the liquid is granulated into particles by a particle producing device and the distance to the object is set to 100 mm or longer, by which an enhanced effect can be expected since the particles are dried to some extent while flying over the distance. The particle producing device may be any of, although not particularly limited, a particle production type using an air spray, an airless spray, a rotary atomizer, and an ultrasonic wave, and a combination thereof, a type capable of pattern coating as disclosed in U.S. Pat. No. 5,389,148 assigned to the applicant of the present invention (Japanese Patent No. 2584528 (JP 4-35767 A “method of applying a liquid or molten material”)), and an ink jet type. Those may be used in combination. In addition, use of “aerocoat” (trademark of Nordson K.K.) for granulating the liquid into a primary particle and applying the particles is ideal because it enables application in a form as close to powder as possible and thus hardly causes swelling of “Nafion”®. The “aerocoat” is as disclosed in Japanese Patent Nos. 2596450, 2660424, and 2796826) assigned to the applicant of the present invention.

With any type of method, it is preferable to reduce the coating film thickness for each application as much as possible and to perform the application plural times. The application is repeated 2 to 100 times, preferably 2 to 10 times from the viewpoint of the productivity. For the electrode ink, nozzle is likely to clog owing to carbon aggregation or precipitation. For the air spray, the flow rate increases to 10 ml/min. or higher if a nozzle aperture size is increased to, for example, 0.5 mm. As a result, the aforementioned traverse speed is set to 20 m/min. or higher or if required, to about 60 m/min. If the traverse speed is high, the spray particles hardly adhere to the object, leading to a considerable reduction in coating efficiency. Accordingly, the traverse speed is desirably in a range of 0.5 m/min. to 20 m/min. In particular, to attain satisfactory productivity and coating efficiency, the speed is desirably set to fall within a range of 2 m/min. to 6 m/min. Used as a method of reducing the flow rate to 1/10 or less, for example, without clogging the nozzle, is a pulse spray method as disclosed in Japanese Patent No. 1651672 (JP 3-18506 B) assigned to the applicant of the present invention. Further, even in an air spray method, pulse spray may be adopted to blow compressed air necessary for granulation, thereby reducing the actual air blowing time to ½ to ⅕. Therefore, the coating efficiency can be considerably increased by 30 to 60%, for example. For example, the liquid is applied 10 times per second under the conditions of 100 msec/cycle, a coating time of 10 msec, and a traverse speed of 2 m/min (33.3 mm/sec). Thus, with the pattern diameter of 20 mm, recoating is performed 6 times. Also, as for a combination of the slot nozzle and the vacuum-type circulating member, as disclosed in JP 10-76220 A assigned to the applicant of the present invention, in the present invention, the web is preheated to thereby improve the flow condition at the time of coating and to attain an effect of drying. Also, any heating means may be used for a heater of the circulating member with no particular limitation. For example, there are a method of heating water, oil, a solvent, a plasticizer, or the like that can be used as a heat medium and transferring it to the circulating member to thereby heat the circulating member; a heating method using a heated gas, for example, steam or hot air; a heating method using an induction heater; and a heating method using an infrared ray or far infrared ray, all of which can be used singly or in combination. Also used is a method of drying the electrode ink and then coating a substrate that is easily stripped off, for example, PTFE, with the ink, drying the substrate, and then press-bonding and transferring it to “Nafion”®. Even for such a substrate, the electrode ink is granulated and lapped in a small amount at a time for allowing the substrate to strip off with ease, by which the substrate can strip off more easily in the above press-bonding step and a high-quality product can be obtained. In particular, when the technique of U.S. Pat. No. 5,389,148 is applied thereto, coating in a desired pattern can be performed with a relatively high production rate. Hence, this is ideal for coating. The stripping substrate has a smooth surface, and is hardly swelled and can withstand a relatively high temperature (for example, 80° C.) as compared to the temperature (40 to 50° C.), which “Nafion”® can withstand. For that reason, a sufficient effect may be obtained only thorough heating without sucking the object from the circulating member side and making the object adhere thereto. In particular, for the high-speed production or simple pattern coating, using the slot nozzle is more preferable. In general, a wet film formed in one application with a thickness of 100 a or more suffers from generation of blisters or cracks during post-heating. However, when, by applying the liquid 2 to 10 times on the heating circulating member so that the film obtained after the application is relatively thin at, for example, 10 to 20 μm in wet thickness, the film can be dried by 20% or more by the next application step, and by recoating the ink thereafter, the problem of the cracks etc. can be solved. This is true irrespective of whether or not the object is made to adhere to the circulating member. A contact surface of the circulating member having no object sucked thereon, where the circulating member contacts the substrate, is preferably as smooth as possible for forming a thin ink wet film. It is desirable for the surface to have a surface roughness of 0.6 S or smaller, for example. In addition, it is desirable to cause no rotational deflection in a drum shape. The application of the electrode ink has been described so far, but the present invention is not particularly limited to a specific type of liquid or final product. According to the present invention, by using the above method and the slot nozzle, the electrolyte solution is applied on a surface-finished endless belt made of a film or metal and dried, and optionally lapped and dried, to thereby produce an electrolyte membrane. In addition, by applying the technique of JP 10-76220 A, it is also possible to fill the electrolyte solution into the air-permeability substrate serving as a frame for the electrolyte membrane, and optionally repeat the above operation or perform coating and drying to thereby produce a high-value-added electrolyte membrane. In those cases, the electrolyte solution is supplied to a closed circuit for supplied solution and heated, which preferably reduces its viscosity and improves its flow condition, and shortens the drying time.

In particular, if the application in a wet state is desired, the object is cooled at the instant when the liquid is applied, to thereby form a coating film by a solvent condensing action, after which the film can be dried through heating the circulating member according to a method disclosed in Japanese Patent No. 1931307 (JP 6-61530 B (JP 2-122873 A “applying method for aerosol”)).

Also, this drying operation can be realized with vacuum drying that attains a higher drying efficiency or with the actions of vacuum drying and heating with the heater. In this case, it is necessary to dry the coating film surface at least to the touch so as to prevent the coating film from adhering to a feed roll pair provided at an inlet of the vacuum chamber, i.e., at the interface with the atmosphere.

According to the present invention, the application operation may be conducted by making the web that is formed by cutting away a desired pattern self-adhere to the object, or by forming, an adhesive layer or a lightly adhesive layer is formed on a contact surface between the web and the object to overlap the web and the object with each other. A suitable self-adhering web is an ST self-adhesive film produced by Achilles Co. Ltd. As the adhesive, any adhesive generally used for a label or tape may be used but is preferably a UV curable adhesive of low adhesion having a chemical resistance.

### FIRST EMBODIMENT

Hereinafter, the present invention will be described based on preferred embodiments thereof with reference to the accompanying drawings.

(Overall Structure)

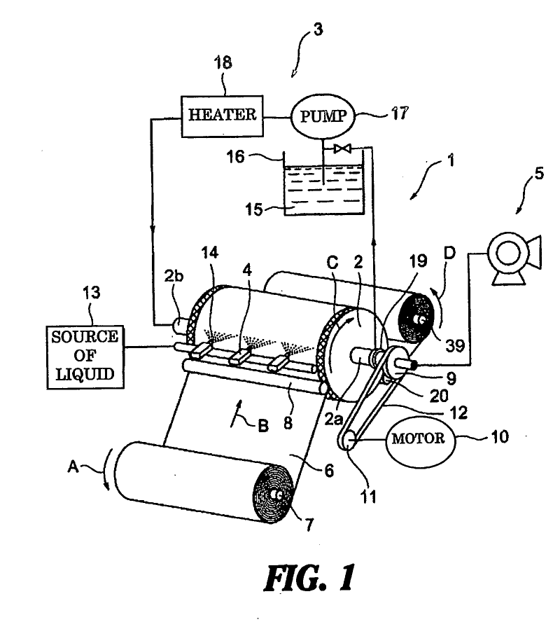

FIG. 1 is a schematic diagram showing an applying and drying device 1 for carrying out a method of applying and drying a liquid according to the present invention. The applying and drying device 1 includes: a rotatable circulating member 2; a heater 3 for heating the circulating member 2; an applying device 4 for applying the liquid; and a vacuum device 5 for evacuating the inside of the circulating member 2.

A web 6 as an object is continuously wound around a take-up spindle 7. When the take-up spindle 7 is rotated in a direction indicated by the arrow A of FIG. 1, the continuous web 6 is moved in a direction indicated by the arrow B of FIG. 1 toward the circulating member 2. The web 6 is guided by a guide roll 8 to wind around the circulating member 2. The circulating member 2 has air-permeability. Therefore, when the vacuum device 5 produces a vacuum inside the circulating member 2, the web 6 is sucked on the surface of the circulating member 2. A pulley 9 is provided to a shaft 2a of the circulating member 2. The pulley 9 is connected to a pulley 11 of a motor 10 through a belt 12. The circulating member 2 is rotated in a direction indicated by the arrow C of FIG. 1 in accordance with the rotation of the motor 10.

The applying device 4 is connected to a source of liquid 13. The applying device 4 applies a liquid 14 from the source of liquid 13 to the web 6 sucked on the circulating member 12.

The heater 3 includes: a medium container 16 containing a heat medium 15; a pump 17 for pumping the heat medium 15 from the medium container 16 to the circulating member 2; and a heater 18 for heating the heat medium 15. The heat medium 15 heated by the heater 18 is transferred to the inside of the circulating member through the shaft 2b of the circulating member 2 to heat the circulating member 2 and recovered therefrom to the medium container 16 through a sealing member 19 provided to the shaft 2a.

Since the circulating member 2 is heated with the heat medium 15, the liquid applied to the web 6 is heated and dried. The liquid applied to the web 6 becomes dry to the touch or dry by the time when the web 6 reaches a guide roll 20. The web 6 is taken up on a take-up spindle 39 rotating in a direction indicated by the arrow D of FIG. 1.

The term “dry to the touch” used herein generally refers to a dry state of a coating, in which the tips of the fingers are not stained with the coating when the center of the application surface is touched with the tips of the fingers. In other words, in this embodiment, at a position where the web 6 is stripped off from the circulating member 2, the web 6 is preferably heated and dried to such an extent that, when softly pressing the tips of the fingers against the liquid applied on the web 6, the liquid does not adhere to the fingers.

(Circulating Member)

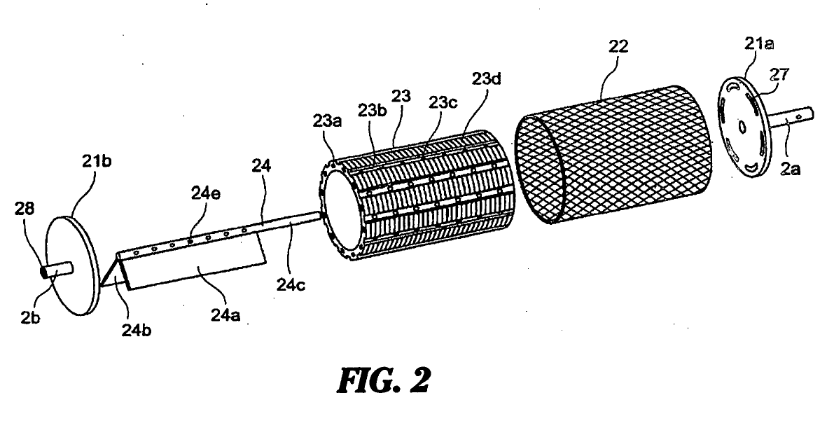

Referring to FIGS. 2 to 5, the circulating member 2 is described in more detail below.

FIG. 2 is an exploded view showing the circulating member 2. The circulating member 2 is composed of a flange 21a having the shaft 2a held by a bearing (not shown), a flange 21b having the shaft 2b held by a bearing (not shown), a screen drum 22, a cylinder 23, and a vacuum pipe 24 equipped with two partition plates 24a and 24b.

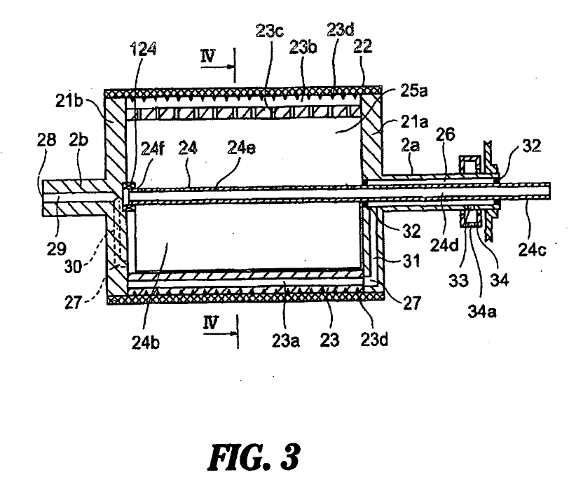

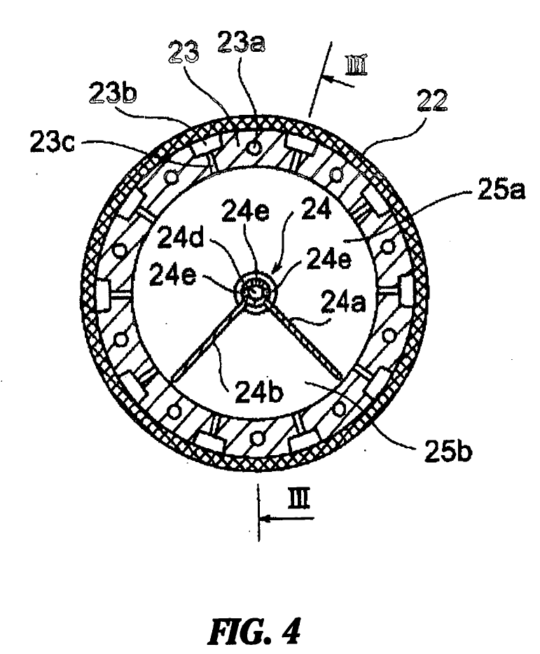

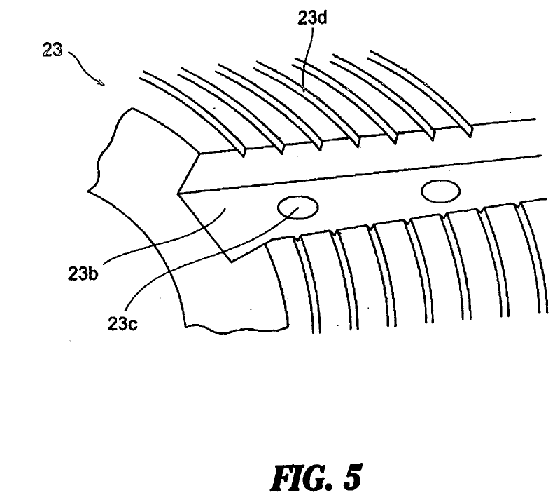

FIG. 3 is a sectional view taken along an axial direction of the circulating member 2 and along the line III-III of FIG. 4. FIG. 4 is a cross-sectional view of the circulating member 2 taken along the line IV-IV of FIG. 3. FIG. 5 is a partial enlarged view showing the surface of the circulating member 2.

The cylinder 23 is a cylindrical member whose both ends are open. A plurality of oil holes 23a are formed while passing through the cylinder 23 in the axial direction. A plurality of grooves 23b extend in the axial direction on the outer surface of the cylinder 23. The grooves 23b have plural air holes 23 passing through the cylinder 23 in the radial direction. A large number of turning grooves 23d are formed in the circumferential direction on the outer surface of the cylinder 23.

The cylinder 23 is made of a material having a high heat conductivity. The material is preferably, although not particularly limited, metal having a high heat conductivity such as aluminum, copper, or brass. When used in an atmosphere containing a corrosive gas, the cylinder 23 is preferably subjected to plating. For example, “NEDOX”® or “TUFRAM”® treatment as a type of fluororesin treatment is preferred from the viewpoint of preventing the liquid as a coating material from adhering to the cylinder 23. The “NEDOX” treatment is a surface treatment technique which offers a high-performance composite membrane that has a high hardness and is excellent in abrasion resistance, slidability, antigalling property, non-adhesiveness, weatherability, oil resistance, or the like, the composite membrane having an extremely smooth and hard surface and being excellent in terms of adhesion to a base material. The “TUFRAM” treatment is a surface treatment technique which offers a high-performance composite membrane integrated with a base material and having excellent abrasion resistance, slidability, releasing property, corrosion resistance, corrosion resistance in seawater, electric insulation, or the like, and an extremely smooth and hard surface.

The vacuum pipe 24 is placed inside the cylinder 23. The vacuum pipe 24 has the two partition plates 24a and 24b which separate the inside of the cylinder 23 into a vacuum chamber 25a and an air communication chamber or pressurizing chamber 25b. The vacuum pipe 24 is connected to the vacuum device 5 at one end (24c) through a through-hole 26 formed in the flange 21a. The vacuum pipe 24 has its other end (24f) held by the flange 21b through a bearing 124. The vacuum device 5 evacuates the air from the inside of the vacuum chamber 25a through an air passage 24d extending in the axial direction of the vacuum pipe 24 and the large number of air holes 24a formed in the vacuum pipe 24 to generate a vacuum inside the vacuum chamber 25a. The vacuum state inside the vacuum chamber 25a is not particularly limited but the inner pressure may be reduced to a vacuum degree of 1.3 kPa to 80 kPa.

The flanges 21a and 21b are attached to both ends of the cylinder 23. The flanges 21a and 21b have oil grooves 27 for communicating the adjacent oil holes 23a of the cylinder 23. The shaft 2b of the flange 21b has an inlet 28 for the heat medium. The inlet 28 allows the heat medium from the heater 16 to pass therethrough. The heat medium passes through a heat medium passage 29 extending in the axial direction of the shaft 2b and through a radial-direction heat medium passage 30 extending in the radial direction of the flange 21b, and reaches the oil grooves 27. Each oil groove 27 communicates with the corresponding one of the plural oil holes 23a, and hence the heat medium moves to the flange 21a through the oil hole 23a. The heat medium thereafter reaches the oil groove 27 of the flange 21a and flows in the adjacent oil hole 23a. The heat medium thus moves reversely to the flange 21b this time and reaches the oil groove 27 of the flange 21b to flow in the adjacent oil hole 23a. In this way, the transfer medium flows in the radial-direction heat medium passage 31 formed in the flange 21a after flowing through all the oil holes 23a of the cylinder 23. The radial-direction heat medium passage 31 communicates with the through-hole 26 formed in the flange 21a. The through-hole 26 has, at its either end, the sealing member for sealing the space defined by the inner surface of the through-hole 26 and the outer surface of the one end 24c of the vacuum pump 24. The heat medium is passed through the through-hole 26 and recovered to an upstream side of the pump 17 via a mechanical seal 34 through a hole 34a thereof from an outlet 33 provided to the shaft 2a, thus circulating through this system.

The screen drum 22 is fitted to the cylinder 23 from outside the cylinder. The screen drum 22 as a porous member is fixed to the cylinder 23 and rotated in accordance with the rotation of the cylinder 23.

If a vacuum is produced inside the vacuum chamber 25a, a vacuum is also generated inside the groove 23b through the plural air holes 23c of the cylinder 23. The groove 23b communicates with the large number of turning grooves 23d in the circumferential direction of the cylinder 23 and a vacuum is thus produced in the outer surface of the cylinder 23. Since the screen drum 22 is an air-permeability porous member, a suction force is generated in the outer surface of the screen drum 22. Therefore, a substantially uniform suction force is generated over the entire portion of the outer surface of the screen drum 22 corresponding to the vacuum chamber 25a. In contrast, no vacuum is formed in the air communication chamber 25b, and hence no suction force is generated at portions of the outer surface of the screen drum 22 corresponding to the air communication chamber 25b. Accordingly, the web 6 is sucked on the portions of the outer surface of the screen drum 22 corresponding to the vacuum chamber 25a and rotated together with the screen drum 22. The web 6 is stripped off from the screen drum once reaching the portions of the outer surface of the screen drum 22 corresponding to the air communication chamber 25b.

(Another Embodiment (Example) of Circulating Member)

The circulating member is not limited to the aforementioned drum shape but may take any other form insofar as the circulating member can suck the web 6 for heating and drying.

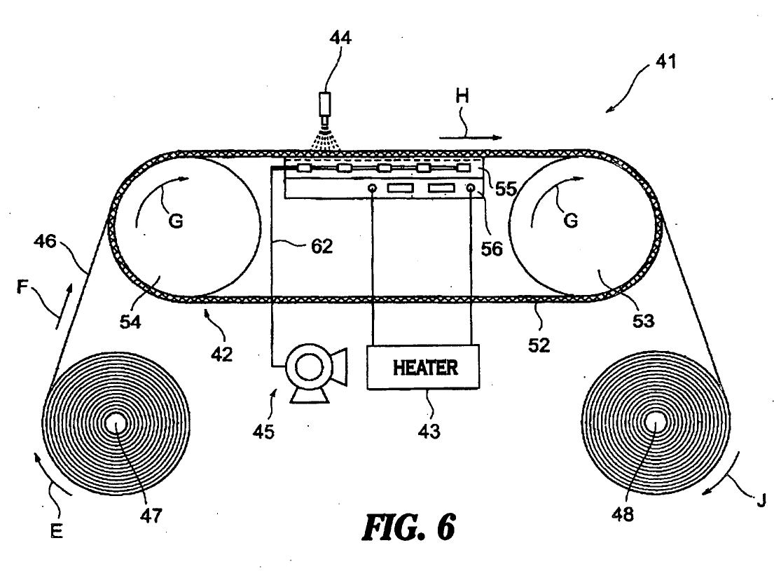

FIG. 6 is a schematic diagram showing a circulating member 42 using a screen belt 52. An applying and drying device 41 shown in FIG. 6 is composed of the circulating member 42 using the screen belt 52, a heater 43 for heating the screen belt 52 and/or a web 46, an applying device 44 for applying a liquid, and a vacuum device 45.

The web 46 as the object is continuously wound around a take-up spindle 47. If the take-up spindle 47 rotates in a direction indicated by the arrow E of FIG. 6, the web 46 is accordingly moved in a direction indicated by the arrow F of FIG. 6 toward the circulating member 42. The screen belt 52 is stretched over two rollers 53 and 54. The rollers 53 and 54 rotate in a direction indicated by the arrow G of FIG. 6, thereby rotating the screen belt 52 in a direction indicated by the arrow H of FIG. 6. The web 46 is sucked on the screen belt 52 of the circulating member 42 by the vacuum device 45 generating a vacuum therein. The applying device 44 is disposed opposite to the circulating member 42 and adapted to apply the liquid on the web 46. The circulating member 42 is heated through the heat medium by the heater 43. Hence, the liquid applied on the web 46 is heated and dried. The liquid applied on the web 46 is almost dry to the touch by the time when the web 46 is stripped off from the screen belt 52 at the roller 53. The web 46 is wound around a take-up spindle 48 rotating in a direction indicated by the arrow J of FIG. 6.

The circulating member 42 is composed of the screen belt 52, a vacuum plate 55, and a heating plate 56.

The screen belt 52 is an air-permeability porous member.

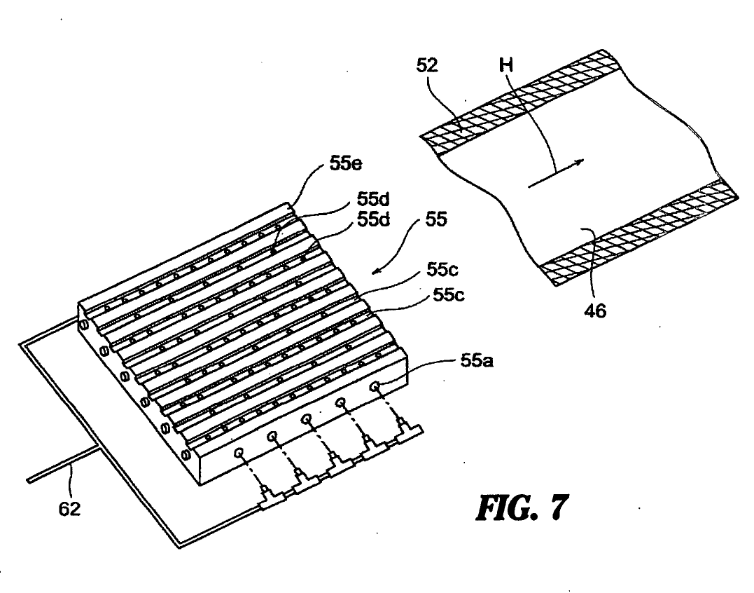

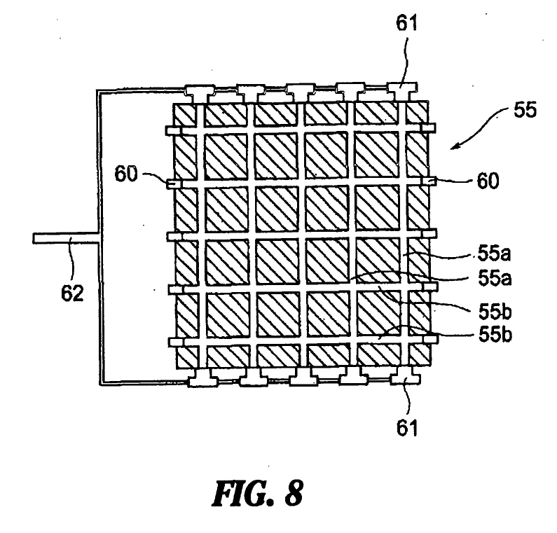

FIG. 7 is a perspective view showing the vacuum plate 55. FIG. 8 is a sectional view of the vacuum plate 55. The vacuum plate 55 has plural through-holes 55a and plural through-holes 55b in a longitudinal direction and a lateral direction, respectively. The surface of the vacuum plate 55 has plural grooves 55c in the lateral direction thereof. The grooves 55c extend in a transporting direction of the web 46 (in a direction indicated by the arrow H of FIG. 7). Plural air holes 55d communicating with through-holes 55a and 55b from the grooves 55c are formed. The through-holes 55b in the lateral direction are closed by plugs 60 being inserted to both ends. The through-hole 55a has its both ends fitted with T-shaped clamps 61 and is connected to the vacuum device 45 thorough a pipe 62.

When the vacuum device 54 evacuates the air, a vacuum is produced in the groove 55c through the pipe 62, the T-shaped clamps 61, the through-holes 55a and 55b, and the air hole 55d. The screen belt 52 continuously moves over plural lands 55e of the vacuum plate 55. The screen belt 52 is made of an air-permeability porous member. Accordingly, the web 46 is sucked on the screen belt 52 and moved together with the screen belt 52 in a direction indicated by the arrow H (FIG. 6).

FIG. 9 is a plan view showing the heating plate 56. The heating plate 56 has plural oil holes 56a passing through the heating plate 56. The outlet and inlet of the adjacent oil holes communicate with each other through fittings 66 having connection holes 66a. An inlet 56b of the oil hole 56a is connected to the heater 43. The inlet 56b allows the heat medium heated by the heater 43 to pass therethrough. The heat medium flows in the oil hole 56a to pass through the connection hole 66a of the fitting 66 and further flows in the adjacent oil hole 56a. The heat medium then passes through the connection hole 66a of the fitting 66 at the opposite end and further flows in the adjacent oil hole 56a. In this way, the heat medium passes through all the oil holes 56a and recovered from the outlet 56c to the heater 43.

When heated with the heat medium, the heating plate 56 transfers the heat to the vacuum plate 55 brought into contact with or placed onto the heating plate 56 surface. The heat is further transferred to the screen belt 52 and/or the web 46 moving in contact with the vacuum plate 55 surface to thereby heat the web 46. In this way, the liquid applied onto the web 46 is heated and dried with the heat transferred from the heating plate 56. The amount of heating of the heating plate 56 is preferably controlled so as to substantially dry the liquid applied onto the web 46 at least to the touch in the position where the web 46 is stripped off from the screen belt 52 at the roller 53.

In this embodiment, the heating plate 56 has no oil hole 56a at the portion opposed to the applying device 44. This is for allowing the applied liquid to infiltrate into the web 46 to some extent. However, the oil hole 56a may be formed in the heating plate 56 at the portion opposed to the applying device 44.

(Additional Drying Device)

An additional drying device may be provided for completely drying the web that has been dry to the touch.

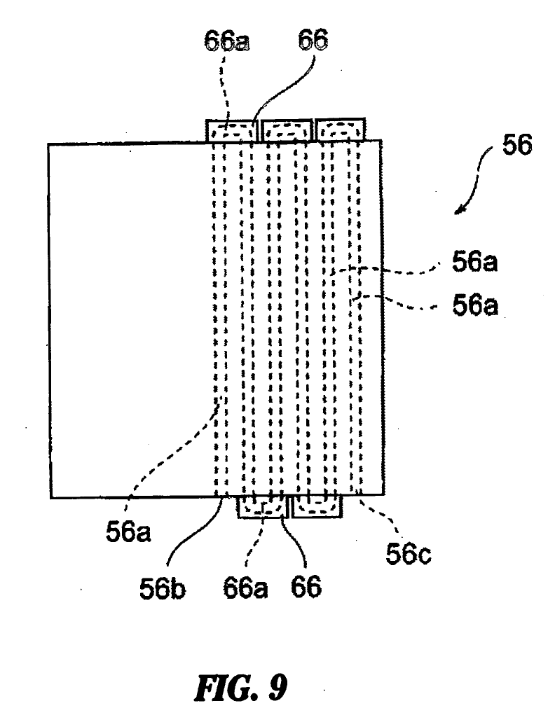

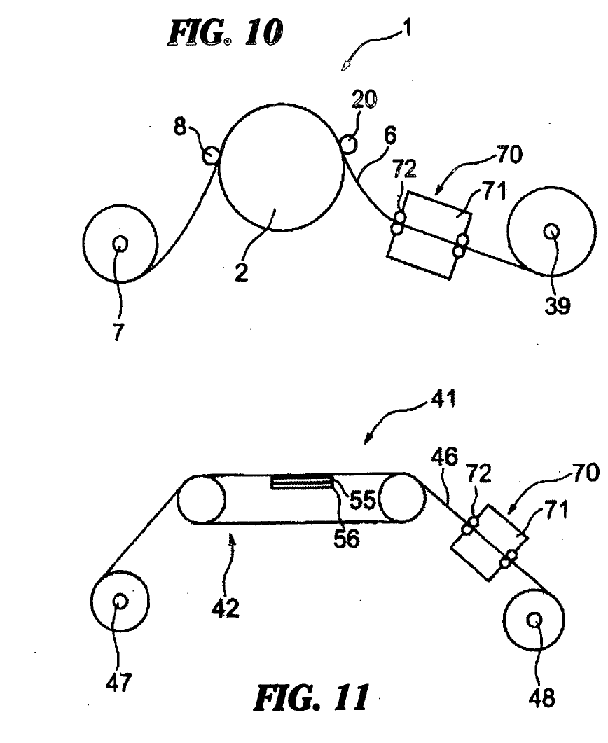

FIG. 10 is a schematic diagram showing an example where a drying device 70 is added to the applying and drying device 1 of FIG. 1. FIG. 11 is a schematic diagram showing an example where the drying device 70 is added to the applying and drying device 41 of FIG. 6. The drying device 70 is placed between the circulating member 2, 42 and the take-up spindle 39, 48. The drying device 70 is composed of a vacuum chamber 71 and a feed roller 72. The drying device 70 dries the liquid while promoting evaporation of the solvent in the liquid applied to the web in the vacuum chamber 71. The vacuum state inside the vacuum chamber 71 is not particularly limited but the inner pressure may be reduced to an absolute pressure of 1.3 kPa to 80 kPa (hereinafter, a pressure related to the vacuum degree is expressed in terms of the absolute pressure). A product of a desired quality can be obtained, even if “Nafion” contains a large amount of residual solvent, by drying under the condition that the inner pressure of the vacuum chamber 71 be kept within the range of 1.3 kPa to 80 kPa. Note that it is preferable to make the liquid applied on the web substantially dry to the touch by the time when the web reaches the feed roller 72.

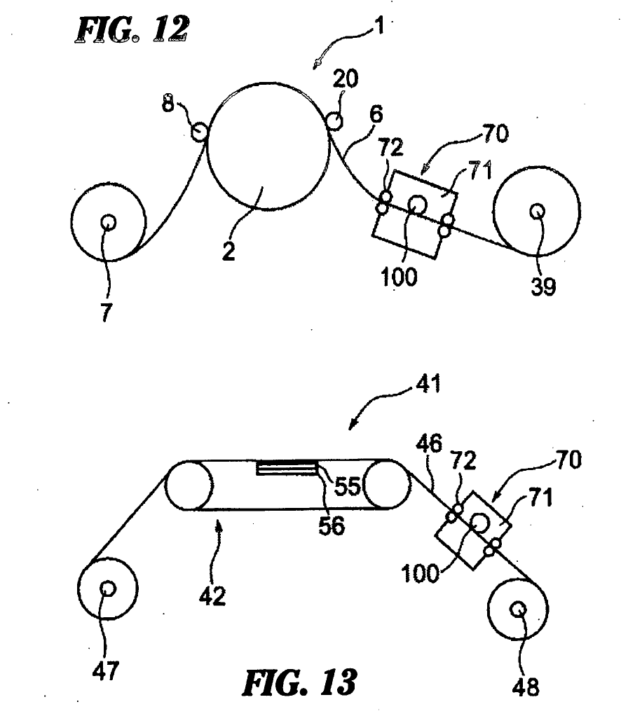

FIGS. 12 and 13 show the drying device 70 having a heating circulating member 100. For further promoting the drying of the web, the heating circulating member 100 is provided inside the vacuum chamber 71. It is possible to promote drying of the web by bringing the circulating member 100 into contact with the web.

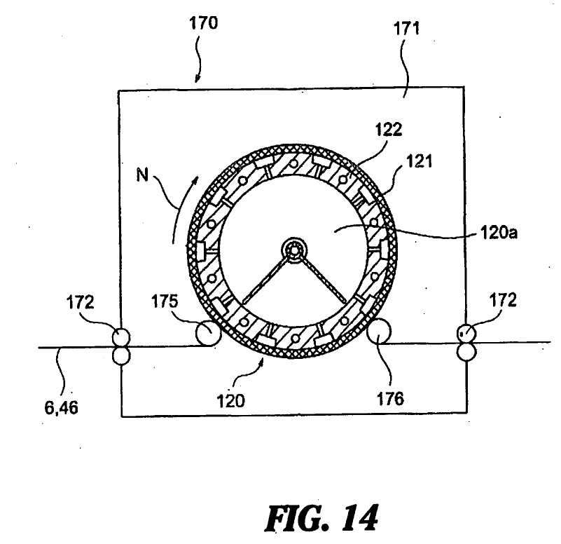

Note that a circulating member 120 having the same structure as the circulating member 2 of FIG. 1 may be used as the heating circulating member of the drying device. FIG. 14 shows a drying device 170 having the heating circulating member 120. The drying device 170 has a vacuum chamber 171, the heating circulating member 120 arranged inside the vacuum chamber 171, and feed rollers 172 disposed at the inlet and outlet of the vacuum chamber 171. The heating circulating member 120 is composed of a screen drum 121, and a cylinder 122 heated through a heat medium. A vacuum chamber 120a is formed inside the cylinder 122. The web 6, 46 is guided into the vacuum chamber 171 by means of the feed roller 172 at the inlet, and guided by a guide roll 175 and sucked on the screen drum 121. The web 6, 46 is rotated in a direction indicated by the arrow N of FIG. 14 and stripped off from the screen drum 121 at a guide roll 176. Thereafter, the web is fed to the outside of the vacuum chamber 171 by means of the feed roller 172 at the outlet. The object is exposed to the vacuum atmosphere in the vacuum chamber while sucked on the heating circulating member 120 and heated through the heating circulating member, thus further promoting drying of the object. Note that, the vacuum state in the vacuum chambers 171 and 120a may be, although not particularly limited, set to meet V1<V2 where V1 represents a vacuum degree of the vacuum chamber 171 and V2 represents a vacuum degree of the vacuum chamber 120a. For example, an inner pressure of the vacuum chamber 171 may be reduced to a pressure P1 in the range of 1.3 kPa to 80 kPa (vacuum degree), and an inner pressure of the vacuum chamber 120a may be reduced to a pressure P2 in the range of 0.1 to 2 kPa. The pressures of the vacuum chambers 171 and 120a are set to meet the relationship of P1>P2. The pressure of the vacuum chamber 120a is preferably lower than that of the vacuum chamber 171. In addition, it is preferable to use vacuum pumps independently for the respective vacuum chambers in order to facilitate control of the vacuum degree of each vacuum chamber. Regarding the vacuum device to be connected to the vacuum chamber 120a, not only the aforementioned absolute pressure thereof is set as low as possible, for example, 0.1 to 2 kPa, but also a pumping power thereof is set to be not smaller than 1 m³/min per 3 m³ of the air-permeability web. This promotes suction of the solvent steam from the air-permeability underlying web to facilitate the drying.

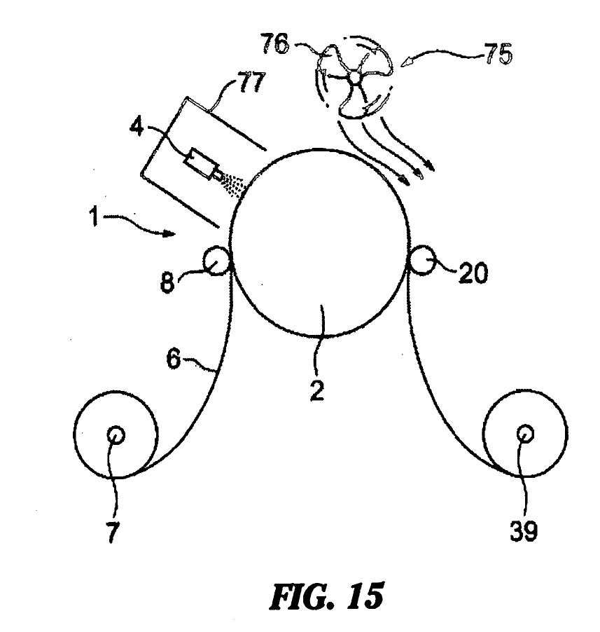

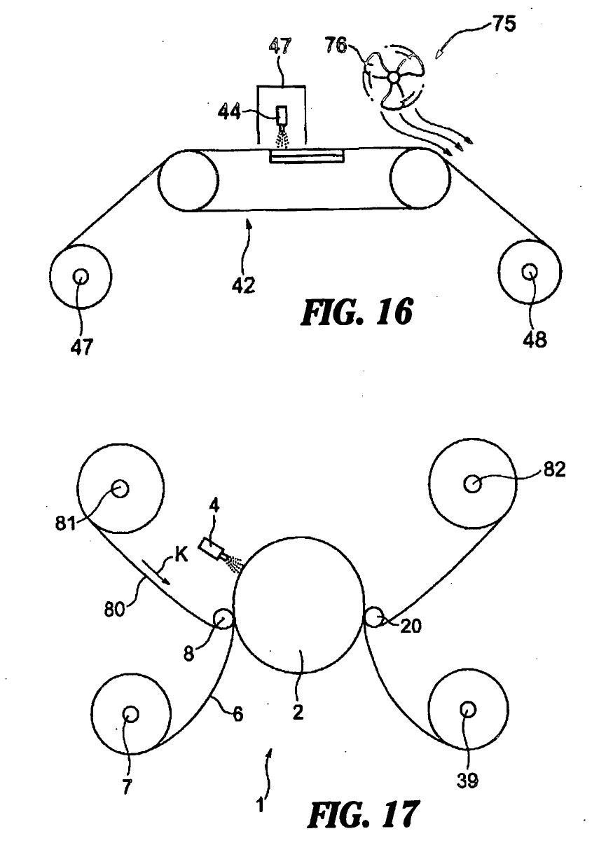

FIG. 15 is a schematic diagram showing an example where a drying device 75 is added to the applying and drying device 1 of FIG. 1. FIG. 16 is a schematic diagram showing an example where the drying device 75 is added to the applying and drying device 41 of FIG. 6. The drying device 75 is provided downstream of the applying device 4, 44 and opposed to the circulating member 2, 42. The drying device 75 is composed of a fan 76 for blowing cold or hot air. The fan 76 is adapted to blow the air at a flow rate of 0.5 to 3 m/s to the liquid applied on the web to promote the evaporation of the solvent in the liquid. Note that if the liquid that is being applied from the applying device 4, 44 is exposed to the air flow, there is a possibility that a liquid application position is shifted. To avoid this, a shielding plate 77 preferably covers the applying device 4, 44. It is preferable to maintain the air flow rate inside the shielding plate 77 in the range of 0.1 to 0.8 m/s.

Here, it is possible to use the vacuum drying device 70 and any other heating means for directly or indirectly heating the web or coating film (for example, infrared, far infrared, or induction heating) in combination.

(Masking Web)

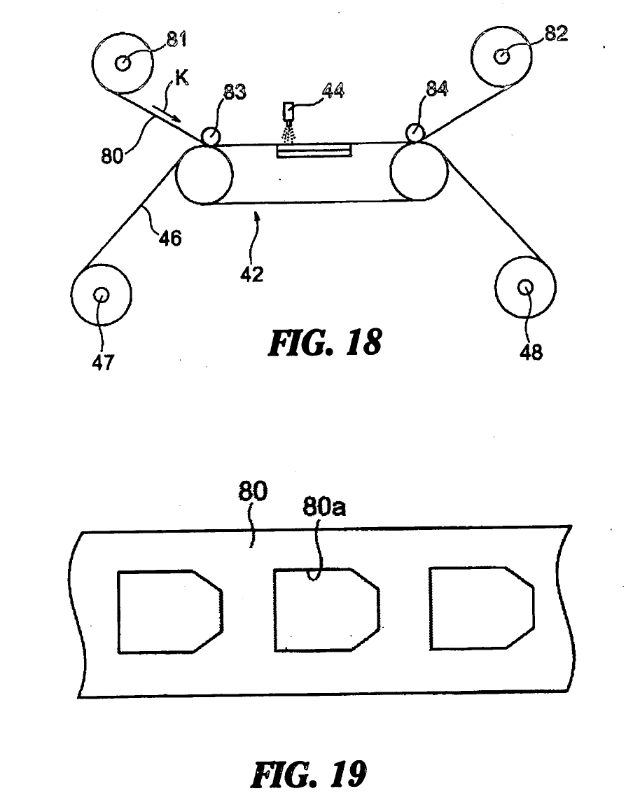

FIG. 17 is a schematic diagram showing an example where a masking web 80 is used for the applying and drying device 1 of FIG. 1. FIG. 18 is a schematic diagram showing an example where the masking web 80 is used for the applying and drying device 41 of FIG. 6. In FIG. 17, the masking web 80 is wound off from a take-up spindle 81 in a direction indicated by the arrow K and guided by the guide roll 8 to overlap with the web 6 as the object sucked on the circulating member 2. As shown in FIG. 19, an opening 80a of a desired shape is formed in the masking web 80. Therefore, the liquid applied from the applying device 44 adheres to the web 46 in the desired shape. The masking web 80 is taken up on a take-up spindle 82 through the intermediation of the guide roll 20. Similarly, in FIG. 18, the masking web 80 is wound off from the take-up spindle 81 in a direction indicated by the arrow K and guided by a guide roll 83 to overlap with the web 46 as an object sucked on the circulating member 42. The opening 80a of the desired shape formed in the masking web 80 allows the liquid applied by the applying device 44 to adhere to the web 46 in the desired shape. The masking web 80 is taken up on the take-up spindle 82 through the intermediation of a guide roll 84.

In this way, the application pattern of the desired shape can be precisely applied to the web 6 or 46 by using the masking web 80 instead of using general masking jig, tape, or device that is somewhat cumbersome to use.

The masking web 80 to come into contact with the web 6, 46 as an object desirably self-adheres thereto but its surface may be applied with an adhesive. Alternatively, the masking web 80 may be formed of a self-adhesive film. By imparting the adhesion to the making web 80 in such a manner, it is possible to avoid misalignment between the masking web 80 and the web 6, 46 as the object, thereby applying the liquid with a higher precision.

(Underlying Web)

An underlying web 90 as an air-permeability substrate may be arranged between the web as an object and the circulating member.

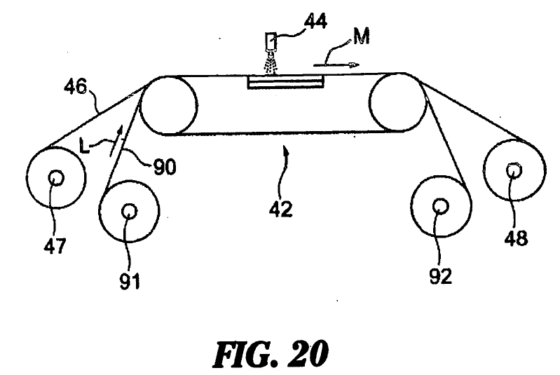

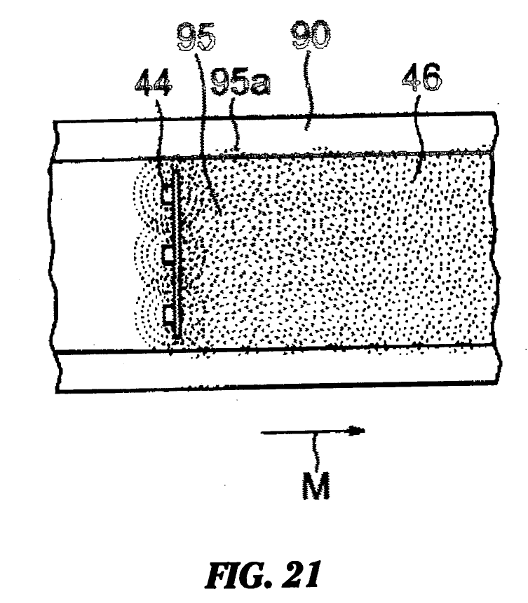

FIG. 20 is a schematic diagram showing an example where the underlying web 90 is used for the applying and drying device 41 of FIG. 6. In FIG. 20, the underlying web 90 is wound off from a take-up spindle 91 in a direction indicated by the arrow L and sucked on the circulating member 42. The underlying web 90 underlies the web 46 as an object, that is, the underlying web 90 is sandwiched between the circulating member 42 and the web 46. The underlying web 90 is an air-permeability web such as paper. FIG. 21 is a plan view illustrative of how the applying device 44 of FIG. 20 applies a liquid. The width of the underlying web 90 is larger than that of the web 46. The underlying web is sucked on the air-permeability circulating member and allows the air to permeate in portions other than the web 46. Thus, the solvent in the applied liquid passes through the circulating member and discharged to the outside by the vacuum device such as a vacuum pump. This promotes the drying of the liquid. The web 46 overlaps the underlying web 90 and moves in a direction indicated by the arrow M of FIGS. 20 and 21. A liquid 95 from the applying device 44 is applied on the web 46. At this time, a trace amount of liquid is scattered to the outside of the web 46 in some cases. A liquid 95a scattered in this way adheres to the underlying web 90. The underlying web 90 is taken up on a take-up spindle 92.

As discussed above, the use of the underlying web 90 not only prevents the surface of the circulating member from being stained but also allows recovery of the scattered liquid 95a. Thus, an applying and drying device favorable from the viewpoint of environmental sanitation can be provided. Further, there is an additional effect as described below. When aiming to obtain a screen drum with a large diameter or a long screen belt, a seamless material that is high-priced or cannot be produced has to be used in general. However, in the present invention, even if provided with a seam portion, the circulating member does not directly contact the object, so that the problem of a small step produced at the seam portion due to welding etc. can be solved. Further, size and density of the air permeation portion of the air-permeability circulating member can be set small and low, respectively, which realizes cost reduction.

In this example as well, the aforementioned additional drying device 70 and any other heating means can be used in combination.

Note that the underlying web 90 can be used for the applying and drying device 1 of FIG. 1.

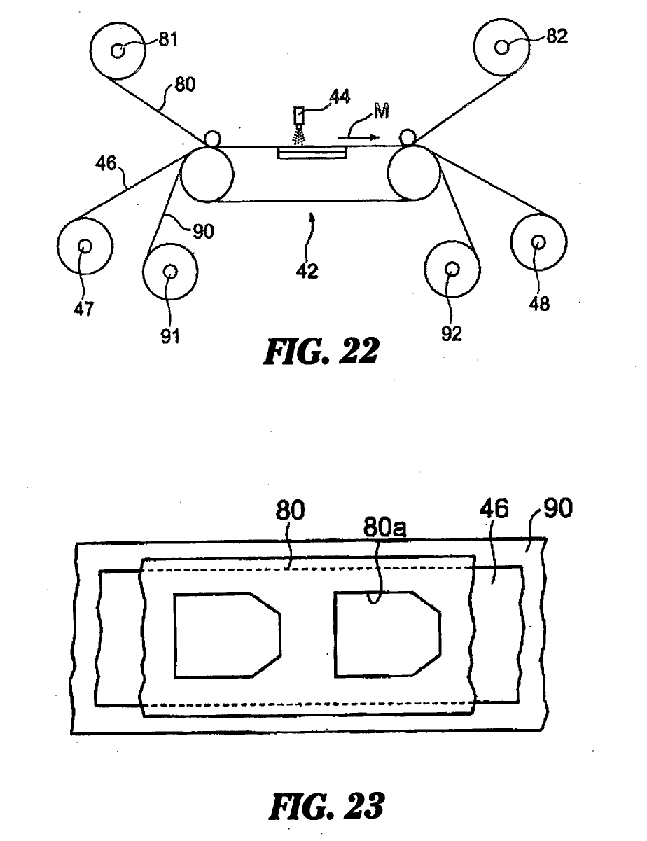

FIG. 22 is a schematic diagram showing an example where the making web 80 and the underlying web 90 are used for the applying and drying device 41 of FIG. 6. The underlying web 90 is interposed between the circulating member 42 and the web 46 as an object. The masking web 80 overlaps the web 46.

FIG. 23 shows how the underlying web 90, the web 46 as an object, and the masking web 80 overlap one another. It is preferable that the width of the masking web 80 be larger than that of the web 46 and the width of the underlying web 90 be larger than that of the masking web 80. With such dimensions, the liquid applied in excess adheres to the masking web 80 and the underlying web 90 to avoid pollution of the surrounding environment. In addition, an application pattern of a desired shape can be formed with precision.

In this example as well, the aforementioned additional drying device 70 and any other heating means can be used in combination.

Note that the underlying web 90 and the masking web 80 may be used for the applying and drying device 1 of FIG. 1.

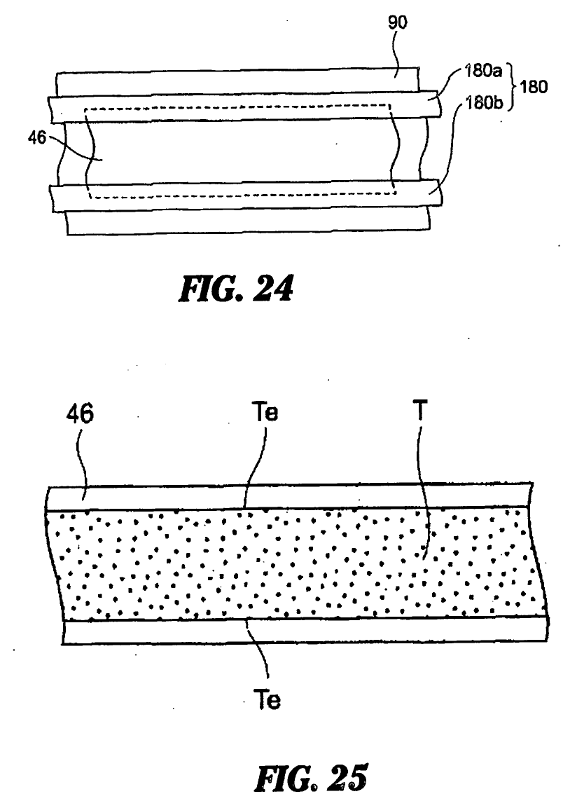

FIG. 24 shows a modification of the masking web. A masking web 180 includes two ribbons 180a and 180b. The web 46 as the object overlaps with the underlying web 90 such that the two ribbons 180a and 180b of the masking web 180 overlap both edges of the web 46. In this state, the liquid is applied.

FIG. 25 shows the web 46 applied with the liquid. Both ends Te of a coating film T can be kept clean. In particular, in the case of spray coating, the both ends Te of the coating film T can be made sharp.

(Multi-Layer Applying Method)

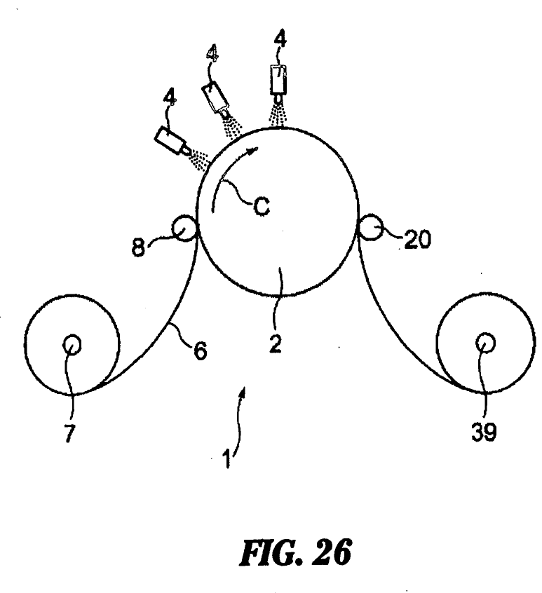

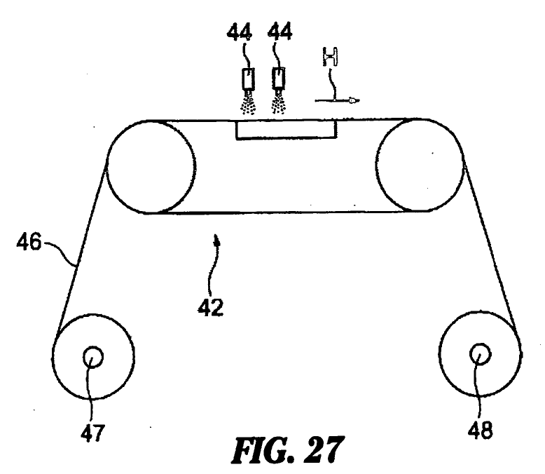

FIG. 26 shows an embodiment of the present invention in which the liquid is applied plural times while stacking the liquid on top of one another. Plural applying devises 4 are arranged along a transporting direction (direction indicated by the arrow C) of the web 6 as an object. The web 6 is sucked on the screen drum and transported. However, if there is no need to suck the web on the screen drum, any generally used drum with no air hole, that is, a roller may be used instead of using the screen drum. The problem of cracks developing in the coating film surface can be solved by stacking plural thin coating films on top of one another. FIG. 27 shows another embodiment of the present invention in which the liquid is applied plural times while stacking the liquid on top of one another. The plural applying devices 44 are arranged along the transporting direction (direction indicated by the arrow H) of the web 46 as an object. The web 46 is sucked on the screen belt and transported. However, if there is no need to suck the web on the screen belt, any generally used belt with no air hole may be used instead of using the screen belt. The problem of the cracks developing in the coating film surface can be solved by stacking plural thin coating films on top of one another.

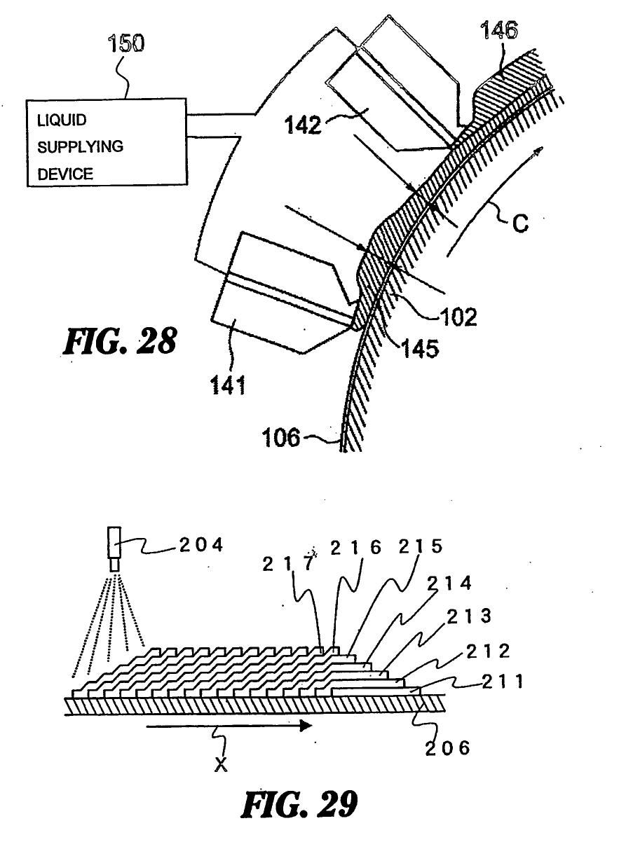

FIG. 28 shows an embodiment of the present invention in which the liquid is applied plural times from plural slot nozzles (141 and 142) while stacking the liquid on top of one another. A web 106 does not always need to be sucked on the heating circulating member. The plural slot nozzles (141 and 142) are connected to a liquid supplying device 150, from which the liquid is applied. The plural slot nozzles (141 and 142) are arranged along the transporting direction (direction indicated by the arrow C of FIG. 28) of the web 106 as an object. The web 106 is transported on the circulating member 102 such as a roller or belt in a direction indicated by the arrow C of FIG. 28. The circulating member 102 may suck the web 106 thereon but in this embodiment, it may transport the web without sucking the web 106 thereon. A liquid 145 is applied on the web 106 from the slot nozzle 141. A coating film of the liquid 145 is set to have a wet thickness of about 20 μm. The distance between the slot nozzle 141 and the web 106 is set to about 50 to 95% of the film thickness of about 20 μm. The coating film of the liquid 145 becomes thinner as the film is dried. When the film thickness is reduced to about 80% or smaller, a liquid 146 is applied from the next slot nozzle 142 and lapped on the coating film of the liquid 145. In this way, recoating offers a high-quality product. In this embodiment, the two slot nozzles are used. However, in the present invention, three or more slot nozzles may be used. The number of slot nozzles is set such that a liquid applied from each nozzle can form a film that is as thin as possible while attaining a desired film thickness.

Using the recoating method makes it possible to produce an electrolyte membrane obtained by applying an electrolyte solution.

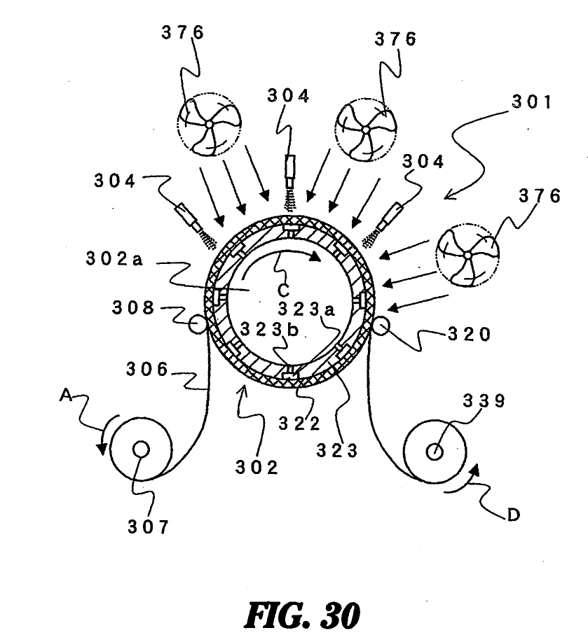

Note that the circulating member 102 with no air permeability may be used. The circulating member 102 with no heater may be used. This is because the object (liquid) can be also dried by blow drying as described later with reference to FIGS. 30 to 32 or drying in a vacuum chamber as described later with reference to FIG. 34.

Also, the object may be made of an air-permeability material, for example, a material serving as a base for the electrolyte membrane. The electrolyte solution is filled and applied to the air-permeability object from the slot nozzle plural times to thereby produce a specific electrolyte membrane.

Further, the recoating method as illustrated in FIG. 28 is performed in the vacuum chamber, making it possible to promote drying of the liquid.

(Applying and Drying in Vacuum Chamber)

The applying and drying device 1, 41 according to the present invention is placed in the vacuum chamber and the liquid may be applied to the web and dried. The entire device is placed in the vacuum chamber, making it possible to prevent pollution of the environment surrounding the device and to promote drying of the liquid.

### SECOND EMBODIMENT

In the first embodiment, the method of applying and drying the liquid by heating the circulating member has been described. However, the present invention is not limited thereto. In a second embodiment of the present invention, a method of applying and drying a liquid without heating the circulating member will be described.

In the second embodiment, in order to solve the problem in the case of applying the liquid on an object that is easily swelled, the liquid is applied into a thin film to thereby promote drying, and a number of thin films of the liquid are stacked on top of one another to thereby obtain a coating film with a desired thickness.

(Stacked Application of Thin Films)

FIG. 29 is a conceptual view illustrative of a method of applying a liquid into a thin film while stacking the thin films on top of one another.

An object 206 is intermittently moved in the transporting direction as indicated by the arrow X of FIG. 29. The liquid is applied into a thin film during a period of suspension of the intermittent movement while moving the applying device 204 in a direction crossing the object (traverse direction), i.e., in a direction perpendicular to the paper surface of FIG. 29. After the liquid is applied into a thin film 211, the object 206 is moved slightly in the transporting direction X and stopped, and then a thin film 212 is formed thereon through the liquid application while moving the applying device 204 in the traverse direction. The thin film 211 and the thin film 212 overlap each other in a slightly misaligned manner. Further, the object 206 is slightly moved in the transporting direction X and stopped, and then a thin film 213 is formed thereon through the liquid application while moving the applying device 204 in the traverse direction. In this way, thin films 214, 215, 216, and 217 are stacked on top of one another in a slightly misaligned manner. By applying the liquid plural times to stack the thin films in such a way, a coating film having a desired thickness can be formed with uniform thickness. The number of times recoating is performed is increased to thereby make the coating film thinner. This makes it possible to raise the drying rate of the liquid.

The thickness of the thin film of the liquid may be set such that the thin film dries immediately after the liquid adheres to the object. For example, if the liquid is applied about 10 to 100 times for forming a 100 μm-thick film, the thickness of the thin film is 1.0 μm to 10 μm, making it possible to dry it very quickly.

As an applying method, the “PULSE SPRAY COATING”® method (pulse spray method) can be used. The “PULSE SPRAY COATING” method is a spray coating method for pulsed spray coating by repeating an ON/OFF operation at an arbitrary period of 8/1,000 sec. or longer by combining an airless gun or two-fluid (air) spray gun capable of high-speed response with a pulse controller. For example, there is a method based on “airless spray coating method” disclosed in Japanese Patent No. 1651673 (JP 3-18507 B) assigned to the applicant of the present invention or “two-fluid spray method” disclosed in Japanese Patent No. 1651672 (JP 3-18506 B). In the case of airless spray, using a crosscut nozzle enables the application of the coating material in the form of fine particles with a sharp particle size distribution. Thus, a thin film with a thickness of the submicron order can be easily formed.

(Blow Drying)

FIG. 30 is a schematic diagram showing a liquid applying and drying device 301 utilizing stacked application and blow drying.

The applying and drying device 301 is composed of a rotatable circulating member 302, applying devices 304 for applying a liquid, a vacuum device (not shown) for evacuating the inside of the circulating member, and a blower 376 for producing an air flow near the application surface.

The circulating member 302 is composed of a screen drum 322 and a cylinder 323. Plural grooves 323a are formed extending on the outer surface of the cylinder 323 in the axial direction. The grooves 323a has plural air holes 323b passing through the cylinder 323 in the radial direction. No oil hole that allows a heat medium for heating to pass therethrough is formed in the circulating member 302.

The blower 376 is placed downstream of the applying device 304. In FIG. 30, the applying device 304 and the blower 376 are alternately arranged.

A web 306 as an object is wound around a take-up spindle 307. When the take-up spindle 307 rotates in a direction indicated by the arrow A of FIG. 30, the continuous web 306 is moved toward the circulating member 302. The web 306 is guided by a guide roll 308 to wind around the circulating member 302. The circulating member 302 has an air-permeability. Therefore, as the vacuum device produces a vacuum in an interior portion 302a of the circulating member 302, the web 306 is sucked on the circulating member 302 surface.

The applying devices 304 are each connected to a source of liquid (not shown). The applying devices 304 each apply the liquid toward the web 306 sucked on the circulating member 302. The application method is a method of applying a number of thin films of the liquid while overlapping them on top of one another. The circulating member 302 is intermittently moved by small increments of, for example, 0.5 to 10 degrees when the diameter of the circulating member 302 is 200 mm and 0.1 to 2 degrees when its diameter is 1000 mm. The liquid is applied while moving the applying devices 304 in the traverse direction (direction perpendicular to the paper surface of FIG. 30) during the time when the circulating member 302 is at rest, thereby forming a thin film. After the circulating member 302 is moved again by a predetermined amount, another thin film of the liquid is further applied so as to be overlapped on the previously formed thin film, and a number of liquid thin films are thus applied while stacked on top of one another.

With the blower 376, an air flow is produced in the vicinity of the liquid applied on the web 306. Increasing the amount of air flow immediately after the application promotes drying of the liquid. For example, the air velocity in the vicinity of the application surface may be increased to 0.5 m/s or higher.

The liquid applied on the web 306 becomes dry to the touch or dry by the time when the web 306 reaches a guide roll 320. The web 306 is taken up on a take-up spindle 339 rotating in a direction indicated by the arrow D of FIG. 30.

While the stacked application of the liquid thin films with the applying devices 304 and the blow drying of the liquid with the blower 376 are alternately repeated plural times in the liquid applying and drying device 301 shown in FIG. 30, the present invention is not limited to this.

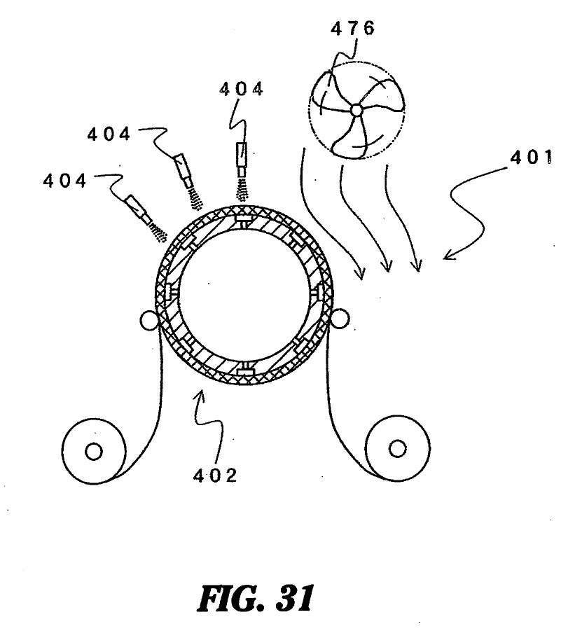

FIG. 31 is a schematic diagram showing another applying and drying device (401). Three applying devices 404 are arranged in series and a blower 476 is provided downstream thereof. Thin films of liquid are applied while stacked on top of one another successively while moving the applying devices 404 in the traverse direction (axial direction of the circulating member 402). Thereafter, with the air flow from the blower 476, the solvent is further evaporated from the liquid to promote drying.

Although the circulating member 402 may be continuously rotated, it is preferred that the circulating member 402 be moved intermittently little by little and the liquid be applied while moving the applying devices 404 in the traverse direction during the time when the circulating member 402 is at rest.

While the three applying devices 404 are provided in FIG. 31, only one applying device may be provided and the stacked application of the liquid thin films may be performed while moving the one applying device multiple times in the traverse direction.

Note that the “PULSE SPRAY COATING”® method may of course be used for the applying devices 304 and 404 of FIGS. 30 and 31, respectively.

(Suction Drying)

The applying and drying devices 301 and 401 respectively shown in FIGS. 30 and 31 are adapted to promote drying of the liquid by increasing the amount of air flow in the vicinity of the application surface immediately after the application of the liquid by use of the blower.

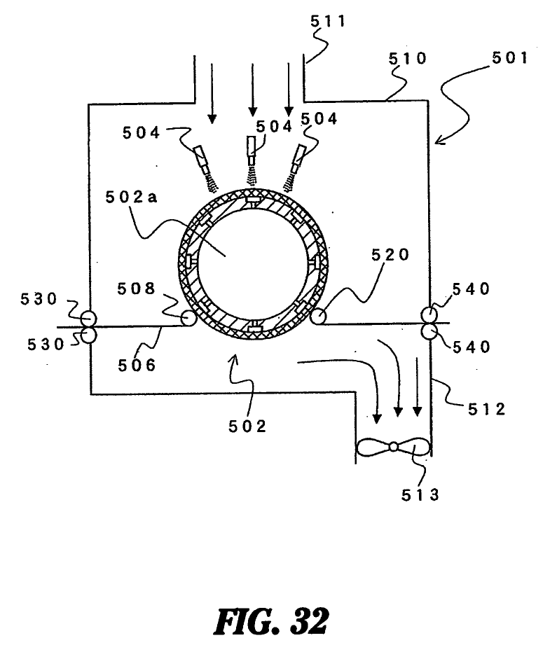

FIG. 32 is a schematic diagram of a liquid applying and drying device 501 using a suction device. The applying and drying device 501 is used for promoting drying of the liquid by increasing the amount of air flow in the vicinity of the application surface immediately after the application of the liquid by use of the suction device.

The applying and drying device 501 has an application chamber 510 composed of an intake port 511 for taking in the outside air, an exhaust port 512 for exhausting air to the outside, and a suction device 513 provided at the exhaust port 513. Provided inside the application chamber 510 are a rotatable circulating member 502 and applying devices 504 that each apply the liquid. Further, the applying and drying device 501 is provided with a vacuum device (not shown) for producing a vacuum in an interior portion 502a of the circulating member 502.

As the suction device 513 operates, air is sucked in from the intake port 511 into the application chamber 510, and the air inside the application chamber 510 is exhausted to the outside from the exhaust port 512. As a result, a flow of air is produced in the vicinity of the application surface.

A web 506 as an object is fed into the application chamber 510 by a pair of inlet rollers 530. The web 506 is guided by a guide roll 508 to be wound around the circulating member 502. Since a vacuum has been produced in the interior portion 502a of the circulating member 502 by the vacuum device, the web 506 is sucked onto the surface of the circulating member 502. While the circulating member 502 may be provided with a heater, no heater is provided in this embodiment.

Applying devices 504 are each connected to a liquid source (not shown). The applying devices 504 each apply the liquid toward the web 506 sucked on the circulating member 502. The application method is a method of applying multiple thin films of the liquid while overlapping them on top of one another. The circulating member 502 is moved intermittently. The liquid is applied while moving the applying devices 504 in the traverse direction (direction perpendicular to the paper surface of FIG. 32) during the time when the circulating member 502 is at rest, thereby forming a thin film. After the circulating member 502 is moved again by a predetermined amount, another thin film of the liquid is further applied so as to be overlapped on the previously formed thin film, and multiple liquid thin films are thus applied while stacked on top of one another. Since the liquid is applied on the web 506 in the form of a thin film, evaporation of the solvent from the liquid takes place instantaneously, enabling fast drying of the liquid.

Since a flow of air has been produced in the vicinity of the application surface by the suction device 513, the drying of the liquid is further promoted. The liquid applied on the web 506 becomes dry to the touch or dry by the time when the web 506 reaches a guide roll 520. The web 506 is fed out to the outside of the application chamber 510 by a pair of outlet rollers 540.

Note that the “PULSE SPRAY COATING”® method may of course be used for the applying devices 504 of FIG. 32.

(Underlying Web)

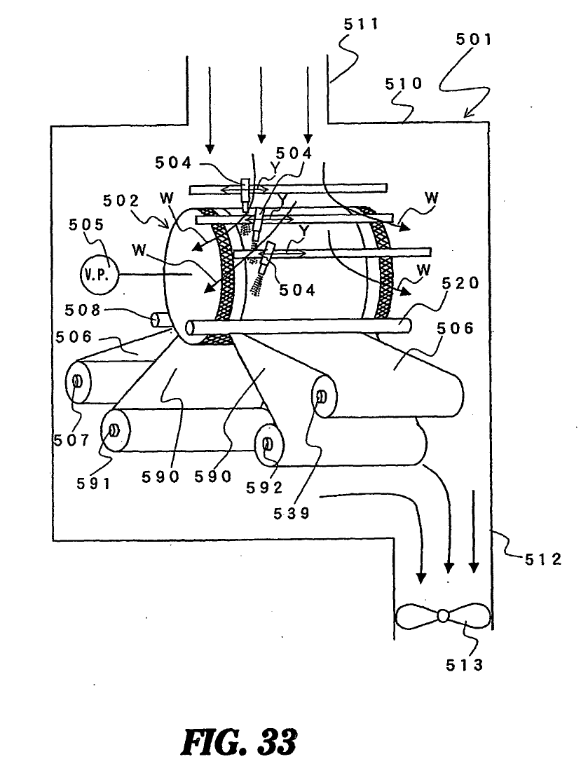

FIG. 33 is a schematic diagram showing an example in which an underlying web is used in the liquid applying and drying device 501 using the suction device. The same structural portions as those shown in FIG. 32 are denoted by the same symbols and a description thereof is omitted.

In FIG. 33, an underlying web 590 as an air-permeability medium is arranged between the web 506 as an object and the circulating member 502. The underlying web 590 is a web having air permeability such as paper. The width of the underlying web 590 is larger than the width of the web 506 as the object.

The web 506 as the object is wound off toward the circulating member 502 from a take-up spindle 507. The underlying web 590 is wound off toward the circulating member 502 from a take-up spindle 591. The underlying web 590 underlies the web 506 as the object, that is, the web is sandwiched between the circulating member 502 and the web 506. The circulating member 502 is connected to a vacuum device 505 so that a vacuum is produced in the interior portion of the circulating member 502. The surface of the circulating member 502 has air permeability, so that the underlying web 590 and the web 506 as the object are sucked onto the surface of the circulating member 502. Although the circulating member 502 is provided with no heater, it is to be understood that the circulating member 502 may be provided with a heater.

The circulating member 502 is moved intermittently little by little. The liquid is applied while moving the applying devices 504 in the traverse direction as indicated by the arrow Y of FIG. 33 (direction perpendicular to the transporting direction of the web 506) during the time when the movement of the circulating member 502 is suspended. The liquid applied from each applying device 504 adheres to the web 506. The intermittent movement of the circulating member 502 and the application of the liquid from each applying device 504 are repeated, thereby forming a laminate of liquid thin films on the web 506.

When applying the liquid from each applying device 504, due to the flow of air as indicated by the arrow W of FIG. 33, a trace amount of the liquid may scatter and spread to the outside of the web 506. The liquid thus scattered adheres to the underlying web 590. The circulating member 502 pulls in the scattered liquid due to a vacuum force through the underlying web 590 having air permeability. Thus, the underlying web 590 also functions as a filter. Further, the underlying web 590 is sucked on the circulating member 502 having air permeability, allowing air to permeate in portions outside the web 506. The solvent in the applied liquid thus passes through the underlying web 590 and the circulating member to be discharged to the outside by the vacuum device, thereby facilitating drying.

The underlying web 590 is taken up on a take-up spindle 592 and the web 506 is taken up on a take-up spindle 539.

While in FIG. 33 the take-up spindles 507, 539, 591, and 592 are arranged inside the application chamber 510, those take-up spindles are preferably arranged outside the application chamber 510.

As described above, the use of the underlying web 590 enables recovery of the scattered liquid. Further, the underlying web 590 functions as a filter, allowing the air exhausted from the vacuum device 505 to be purified. Therefore, it is possible to provide an applying and drying device that is favorable from the viewpoint of environmental sanitation.

Note that the “PULSE SPRAY COATING”® method may of course be used for the applying devices 504 of FIG. 33.

### THIRD EMBODIMENT

The drying of the liquid by the heating of the circulating member has been described in the first embodiment, and the drying of the liquid by the stacked application of liquid thin films has been described in the second embodiment. In a third embodiment, drying of the liquid by application of the liquid within a vacuum chamber is described.

FIG. 34 is a schematic diagram of a liquid applying and drying device 601 using the vacuum chamber. The applying and drying device 601 is composed of a vacuum chamber 610, a vacuum device 650 for producing a vacuum in an interior portion 610a of the vacuum chamber 610, a circulating member 602 provided in the interior portion 610a of the vacuum chamber 610, and an applying device 604 for applying the liquid which is provided in the interior portion 610a of the vacuum chamber 610. A pair of inlet rollers 630 are provided at the inlet of the vacuum chamber 610 and a pair of outlet rollers 640 are provided at the outlet of the vacuum chamber 610.

A web 606 as an object is fed out into the interior portion 610a of the vacuum chamber 610 by the pair of inlet rollers 630. The web 606 is guided by a guide roll 608 to be sucked on the circulating member 602. A vacuum is produced in an interior portion 602a of the circulating member 602 by a vacuum device (not shown) and the circulating member 602 has air permeability, thus allowing the web 606 to be sucked on the surface of the circulating member 602.

Although there is no particular limitation regarding the respective vacuum states in the interior portion 610a of the vacuum chamber 610 and in the interior portion 602a of the circulating member 602, it suffices that they satisfy the relationship of V1<V2 where V1 represents a degree of vacuum in the interior portion 610a of the vacuum chamber 610 and V2 represents a degree of vacuum in the interior portion 602a of the circulating member 602. For example, the vacuum state in the interior portion 610a of the vacuum chamber 610 may be produced under a pressure P1 reduced within the range of 1.3 kPa to 80 kPa, and the vacuum state in the interior portion 602a of the circulating member 602 may be produced under a pressure P2 reduced within the range of 0.1 kPa to 2 kPa. The relationship between the respective pressures in the interior portion 610a of the vacuum chamber 610 and in the interior portion 602a of the circulating member 602 preferably satisfies P1>P2, with the pressure in the interior portion 602a of the circulating member 602 being smaller. Further, while the vacuum device 650 for the interior portion 610a of the vacuum chamber 610 and the vacuum device (not shown) for the interior portion 602a of the circulating member 602 may be made one common device, it is preferred that those devices be provided independently to facilitate individual adjustment of the degrees of vacuum in the respective portions.

Further, while the circulating member 602 is provided with no heater, it may of course be provided with a heater.

The web 606 is sucked on the circulating member 602 and moves as the circulating member 602 rotates. The applying device 604 applies the liquid to the web 606. When applying the liquid, the circulating member 602 may be moved continuously, or the circulating member 602 may be moved intermittently to effect stacked application of the liquid. Further, the “PULSE SPRAY COATING” method may be used. Although only one applying device 604 is depicted in FIG. 34, multiple applying devices 604 may be provided.

The vacuum chamber 610 serves to promote evaporation of the solvent from the liquid applied on the web 606, thus effecting drying of the liquid. The liquid applied on the web 606 becomes dry or dry to the touch by the time when the web 606 reaches a guide roll 620. The web 606 is fed out to the outside of the vacuum chamber 610 by the pair of outlet rollers 640.

(Other Embodiments)

While FIG. 17 shows an example in which the masking web 80 is used for the applying and drying device 1 shown in FIG. 1, a heater may not be provided to the circulating member 2 of the applying and drying device 1. This is because the drying of the object (liquid) may also be effected by the blow drying as shown in FIGS. 30 to 32 or the drying in the vacuum chamber as shown in FIG. 34. The use of the masking web allows the liquid to be applied with precision.

While FIG. 22 shows an example in which the masking web 80 and the underlying web 90 are used for the applying and drying device 41 shown in FIG. 6, a heater may not be provided to the circulating member 42 of the applying and drying device 41. This is because the drying of the object (liquid) may also be effected by the blow drying as shown in FIGS. 30 to 32 or the drying in the vacuum chamber as shown in FIG. 34. The liquid applied in an excess quantity adheres to the masking web 80 and the underlying web 90, thus preventing pollution of the surrounding environment. Further, a desired application pattern can be formed with precision.

As is apparent from the above description, according to the present invention, the liquid applied on the object can be satisfactorily dried, which makes the invention particularly useful.

According to the present invention, a high-quality coating film can be formed by applying a liquid on the object and drying it in a short time.

According to the present invention, the applied liquid can be dried while preventing the object from being excessively swelled with the applied liquid.

The present invention is not limited to the above embodiments but can be implemented in various other forms without departing from the characteristic features of the present invention. Consequently, in all respects, the above embodiments are adopted merely for illustrating the present invention and thus should not be construed as limiting the invention. The scope of the present invention is not limited at all by the description in the specification but is only defined by the appended claims. Further, any modifications and changes made within the scope of equivalents of the claims fall within the scope of the present invention.

1. A method of applying and drying a liquid, comprising:
sucking an object on an air-permeable circulating member;
applying the liquid on the object in a plurality of layers one on top of another; and
drying the liquid applied on the object at least to the touch.

2. A method of applying and drying a liquid according to claim 1, wherein the liquid applied on the object is exposed to an air flow.

3. A method of applying and drying a liquid according to claim 1, wherein the liquid is applied on the object by using a pulse spray method.

4. A method of applying and drying a liquid, comprising:
sucking an object on an air-permeability circulating member in a vacuum chamber;
applying the liquid on the object sucked on the circulating member in the vacuum chamber; and
drying the liquid applied on the object at least to the touch in the vacuum chamber.

5. A method of applying and drying a liquid, comprising:
interposing an air-permeability substrate between an air-permeability circulating member and an object and sucking the air-permeability substrate together with the object to the circulating member to move them with the circulating member;
applying the liquid on the object sucked on the circulating member through the air-permeability substrate; and
drying the liquid applied on the object at least to the touch.

6. A method of applying and drying a liquid, comprising:
making a masking web adhere to a surface of an object;
sucking the object on an air-permeability circulating member;
applying the liquid on the object sucked on the air-permeability circulating member; and
drying the liquid applied on the object at least to the touch.

7. A method of applying and drying a liquid, comprising:
interposing an air-permeability substrate between an air-permeability circulating member and an object and sucking the air-permeability substrate together with the object to the circulating member to move them with the circulating member;
making a masking web adhere to a surface of the object;
applying the liquid on the object sucked on the circulating member through the air-permeability substrate; and
drying the liquid applied on the object at least to the touch.

8. A method of applying and drying a liquid according to claim 1, wherein the circulating member is heated.

9. A method of applying and drying a liquid according to claim 8, wherein a surface of the circulating member comprises an air-permeability screen drum or screen belt, and the screen drum or the screen belt is heated from the inside.

10. A method of applying and drying a liquid according to claim 1, wherein the object is a web.

11. A method of applying and drying a liquid according to claim 1, wherein the applying comprises atomizing the liquid into particles.

12. A method of applying and drying a liquid according to claim 1, wherein a coating film dried at least to the touch on the object is further dried in a vacuum chamber.

13. A method of applying and drying a liquid according to claim 12, wherein at least the coating film is heated by a heater in the vacuum chamber.

14. A method of applying and drying a liquid according to claim 1, wherein the method of applying and drying the liquid is performed in a vacuum chamber.

15. A method of applying and drying a liquid according to claim 1, wherein the liquid is an electrode-ink for a proton-exchange membrane fuel cell, and the object to be coated is an electrolyte membrane.

16. A method of applying and drying a liquid according to claim 1, comprising:
interposing an air-permeability substrate between the object and the circulating member; and
sucking the air-permeability substrate together with the object to the circulating member to move them with the circulating member.

17. A method of applying and drying a liquid according to claim 8, comprising transferring heat from the circulating member to the object so that a surface of a coating film of the liquid on the object is dried at least to the touch until the object is stripped off from the circulating member.

18. A method of applying and drying a liquid according to claim 1, wherein an operation of applying and drying electrode inks for an anode and a cathode is performed in one line.

19. A method of applying and drying a liquid according to claim 1, comprising:
making a masking web self-adhere to the surface of the object; or
making a masking web adhere to the surface of the object with an adhesive.

20. A method of applying and drying a liquid, comprising:
sucking an object on an air-permeability circulating member;
applying the liquid from a slot nozzle on the object sucked on the circulating member while stacking layers of the liquid one on top of another; and
drying the liquid applied on the object at least to the touch.

21. A method of applying and drying a liquid according to claim 20, wherein the object has an air permeability, and wherein the liquid is filled into the object having the air-permeability from the slot nozzle plural times.

22. A method of applying and drying a liquid according to claim 20, wherein the liquid comprises an electrolyte solution.

23. A method of applying and drying a liquid according to claim 20, wherein the object is dried by heating the circulating member.

24. A method of applying and drying a liquid according to claim 20, wherein the object is dried in a vacuum chamber.
